(19) United States
(12) Patent Application Publication
(10) Pub. No.: US 2007/0105001 A1
(43) Pub. Date: May 10, 2007

(54) Fuel cell stack

(75) Inventor: Atsushi Ohma, Kanagawa (JP)

Correspondence Address: FOLEY AND LARDNER LLP;SUITE 500, 3000 K STREET NW, WASHINGTON, DC, 20007, US

(73) Assignee: Nissan Motor Co., Ltd.

(21) Appl. No.: 10/582,222

(22) PCT Filed: Nov. 25, 2004
(86) PCT No.: PCT/JP04/17892

§ 371 Date: Jun. 8, 2006

(30) Foreign Application Priority Data
Dec. 9, 2003 (JP) 2003-410509

(51) Int. Cl. H01M 8/02; H01M 4/94; H01M 8/10; H01M 4/96

(52) U.S. Cl. 429/38; 429/32; 429/44

(57) ABSTRACT

A fuel cell stack (10) comprises a plurality of stacked unit cells (11). Each unit cell (11) comprises a membrane electrode assembly (1a), and separators (1b, 1c) provided with ribs (5b) which contact the membrane electrode assembly (1a) to realize a current collecting function, and gas passages (4b) formed between the ribs (5b) for supplying a gas to a gas diffusion electrode (1p). The interior of the fuel cell stack (10) comprises a first region and a second region having a lower temperature than the first region. Any one of the gas passages (4b), the ribs (5b), and the gas diffusion electrode (1p) is constituted such that the gas diffusion through the gas diffusion electrode (1p) adjacent to the first region is improved beyond the gas diffusion through the gas diffusion electrode (1p) adjacent to the second region.

### FIELD OF THE INVENTION

This invention relates to a fuel cell stack comprising a plurality of stacked unit cells.

### BACKGROUND OF THE INVENTION

To improve the performance of a polymer electrolyte fuel cell, it is important to even out the current density distribution over the surface of each unit cell and reduce the voltage differential between the unit cells.

In JP9-50817A, published by the Japan Patent Office in 1997, the rib width of a separator on the fuel gas side is made narrower at the downstream side of the fuel gas to even out the current density distribution over the surface of each unit cell.

Further, considering that gas diffusion is worse on the oxidant gas side, which uses oxygen, than the fuel gas side, which uses hydrogen, in JP8-203546A, published by the Japan Patent Office in 1996, the rib width of a separator on the oxidant gas side is made narrower than the rib width on the fuel gas side.

### SUMMARY OF THE INVENTION

In the prior art described above, however, although irregularities in the current density caused by a hydrogen gas concentration difference on the upstream and downstream sides of the fuel gas flowing into the separator on the fuel gas side are evened out, irregularities in the current density caused by mass flow distribution accompanying temperature differences over the cell surface are not evened out. In the high temperature regions of the cell surface, the supply gas volume increases, leading to a reduction in the mass flow, and hence the current density decreases as a result of deficient gas diffusion or a difference in the gas concentration.

Moreover, in a fuel cell stack comprising a plurality of stacked unit cells, a difference in the mass flow occurs among the unit cells due to temperature irregularities in the stacking direction of the unit cells, leading to a voltage differential among the unit cells.

It is therefore an object of this invention to suppress reductions in current density caused by a decrease in the mass flow of a reactant gas in a high temperature region in the interior of a fuel cell stack, and thus prevent a deterioration in the performance of the fuel cell.

In order to achieve the above mentioned object, this invention provides a fuel cell stack comprising a plurality of stacked unit cells, wherein each unit cell comprises: a membrane electrode assembly in which a gas diffusion electrode is disposed on each side of a polymer electrolyte membrane; and a separator comprising a plurality of ribs which contact the membrane electrode assembly to realize a current collecting function, and a plurality of gas passages formed between the ribs for supplying a gas to the gas diffusion electrode, the fuel cell stack comprises a first region and a second region in the interior thereof, the first region having a higher temperature than the second region, and at least one of the gas passages, the ribs, and the gas diffusion electrode is constituted such that a gas diffusion through the gas diffusion electrode adjacent to the first region is improved beyond the gas diffusion through the gas diffusion electrode adjacent to the second region.

The details as well as other features and advantages of this invention are set forth in the remainder of the specification and are shown in the accompanying drawings.

### BRIEF DESCRIPTION OF THE DRAWINGS

FIG. 1A is a schematic diagram of a unit cell in a fuel cell stack of this invention.

FIG. 1B is a plan view of an oxidant gas separator used in the unit cell.

FIG. 2 is similar to FIG. 1B, but shows a second embodiment of this invention.

FIG. 3 is a rear view of an oxidant gas separator used in the second embodiment.

FIG. 4 is a plan view of an oxidant gas diffusion electrode used in a third embodiment.

FIG. 5 is similar to FIG. 1B, but shows the third embodiment of this invention.

FIG. 6 is similar to FIG. 1B, but shows a fourth embodiment of this invention.

FIG. 7 is a side view of a fuel cell stack in a fifth embodiment.

FIG. 8 is similar to FIG. 1B, but shows a sixth embodiment of this invention.

### DESCRIPTION OF THE PREFERRED EMBODIMENTS

### First Embodiment

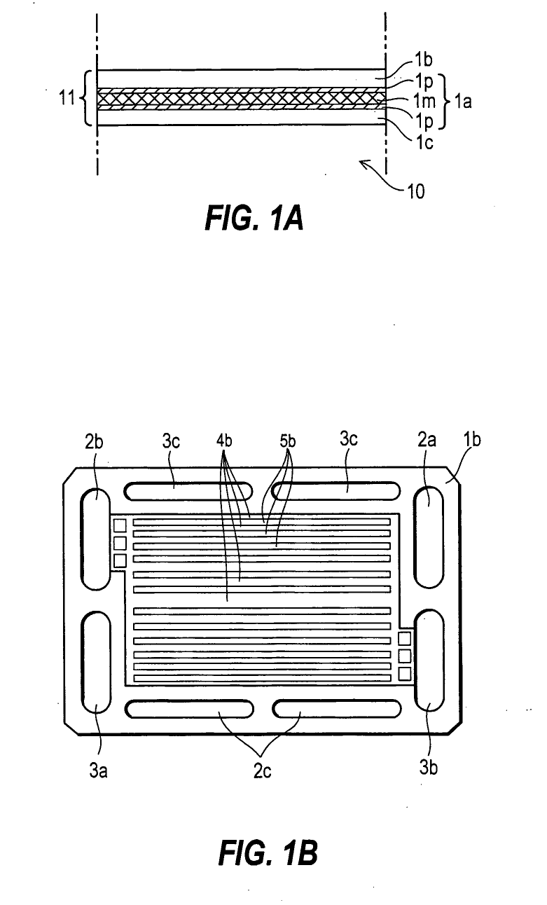

FIG. 1A shows an outline of the constitution of a unit cell 11 in a fuel cell stack 10 according to this invention. The unit cell 11 is constituted by a membrane electrode assembly 1a in which gas diffusion electrodes 1p are disposed on each side of a polymer electrolyte membrane lm, and an oxidant gas separator 1b and a fuel gas separator 1c disposed on each side of the membrane electrode assembly 1a. The fuel cell stack 10 is constituted by a plurality of the unit cells 11 stacked together.

FIG. 1B shows the constitution of the oxidant gas separator 1b. The separator 1b is manufactured from a conductive carbon resin composite. The separator 1b is formed with fuel gas manifolds 2a, 3a, oxidant gas manifolds 2b, 3b, and coolant manifolds 2c, 3c serving as passages allowing fuel gas, oxidant gas, and coolant to flow respectively in the stacking direction of the fuel cell stack 1b. Each manifold serves as either a fluid supply manifold or a fluid discharge manifold.

The separator 1b is provided with a plurality of oxidant gas passages 4b bifurcating from the oxidant gas supply manifold 2b and extending to the oxidant gas discharge manifold 3b. Ribs 5b having a convex cross section and contacting the gas diffusion electrode 1p to realize a current collecting function are provided between the passages 4b. The passages 4b increase gradually in width from the end parts of the surface of the separator 1b toward the center.

If it is assumed that the central region on the cell surface of the unit cell 11 when the fuel cell stack 10 is viewed from the stacking direction is a first region, and the region on the outside thereof is a second region, then the temperature of the first region is higher than the temperature of the second region. In this embodiment, the width of the passages 4b adjacent to the first region is greater than that of the passages 4b adjacent to the second region, and hence these passages 4b have a greater sectional area.

In the fuel cell stack 10, temperature distribution over the cell surface is uneven such that the temperature near the center, where it is difficult for reaction heat to dissipate, is high. As a result of differences in the expansion factor and saturation vapor pressure, a gas temperature differential arises on the surface such that the mass flow of the oxidant gas flowing near the center decreases. This tendency is particularly striking in high current density regions. In this embodiment, however, the passages 4b are constituted as described above, and hence the oxidant gas can flow easily in the vicinity of the cell surface center.

As a result, the gas diffusion near the center of the cell surface is raised beyond the gas diffusion at the end sides, thereby suppressing reductions in current density accompanying a decrease in the mass flow of the reactant gas, and thus a fuel cell stack exhibiting stability and high performance can be obtained even under operating conditions such as high current density, where diffusion limiting is likely to occur.

It should be noted that in this embodiment, the width of the passages 4b increases gradually toward the inside of the cell surface, but the width may be increased in stages several passages at a time. Further, the reason for altering the width of the passages 4b is to increase the sectional area of the passages 4b, and therefore instead of, or in addition to, altering the width of the passages 4b, the depth of the passages 4b may be altered. Moreover, a similar constitution may be applied to the fuel gas side as well as the oxidant gas side.

### Second Embodiment

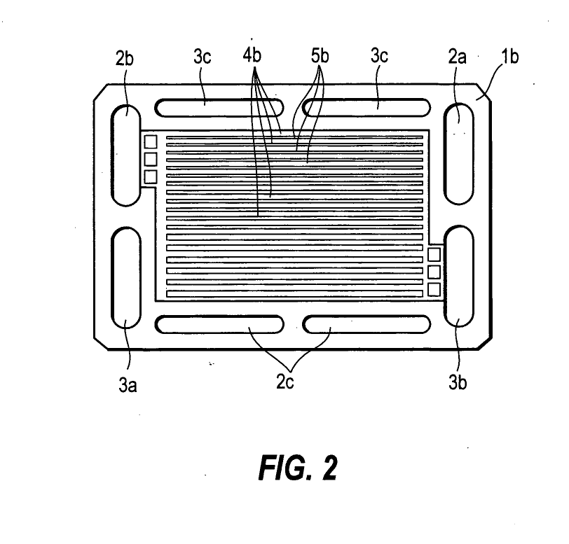

FIG. 2 shows the constitution of the oxidant gas separator 1b used in the unit cell 11 of a second embodiment. The basic constitution of the unit cell 11 is identical to that shown in FIG. 1A. Shared constitutions with the first embodiment have been allocated identical reference numerals, and description thereof has been omitted.

The oxidant gas separator 1b is manufactured from a conductive carbon resin composite. The separator 1b is formed with fuel gas manifolds 2a, 3a, oxidant gas manifolds 2b, 3b, and coolant manifolds 2c, 3c allowing fuel gas, oxidant gas, and coolant to flow respectively in the stacking direction of the fuel cell stack 10. Each manifold serves as either a fluid supply manifold or a fluid discharge manifold.

The oxidant gas separator 1b is provided with a plurality of oxidant gas passages 4b bifurcating from the oxidant gas supply manifold 2b and extending to the oxidant gas discharge manifold 3b. Ribs 5b having a convex cross section and contacting the gas diffusion electrode 1p to realize a current collecting function are provided between the passages 4b. The width of the ribs 5b decreases in stages from the lower part of the separator surface in the drawing toward the upper part.

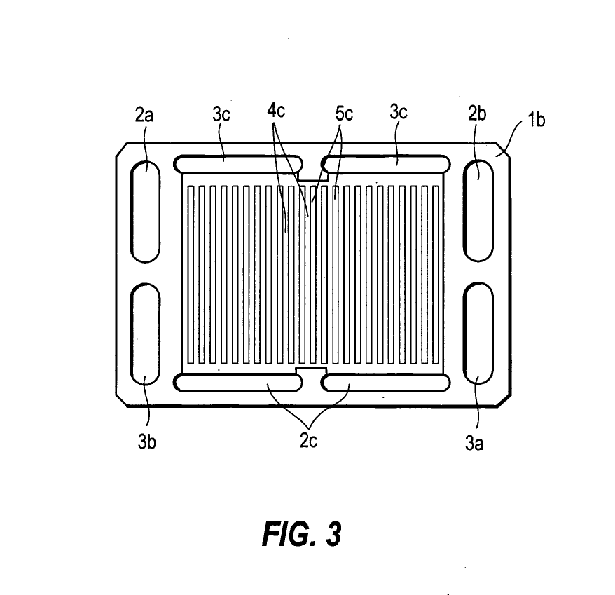

FIG. 3 shows a rear view of the oxidant gas separator 1b shown in FIG. 2. Coolant is introduced into coolant passages 4c from the coolant inlet manifold 2c, and discharged to the outside of the fuel cell stack 10 from the coolant discharge manifold 3c. The region where the ribs 5b of the oxidant gas separator 1b are narrow (the upper part of FIG. 2) is disposed on the rear of the downstream side of the coolant passages 4c. During an operation, the temperature of the coolant and the gas diffusion electrode 1p is highest on the downstream side of the coolant passages 4c.

Hence, assuming that the region near the outlet from the coolant passages 4c is a first region, and the region on the outside of the first region is a second region, the temperature of the first region is higher than that of the second region. In this embodiment, the ribs 5b provided on the oxidant gas separator 1b decrease in width from the lower part to the upper part of the surface of the separator 1b, and therefore the width of the passages 4b adjacent to the first region is greater than the width of the passages 4b adjacent to the second region.

In the fuel cell stack 10, temperature distribution over the cell surface is uneven such that the temperature in the downstream region of the coolant passages 4c is high. This surface temperature differential of the gas causes differences to arise in the expansion factor and saturation vapor pressure, leading to a reduction in the mass flow of the oxidant gas flowing in the upper part of the oxidant gas separator 1b. This tendency is particularly striking in high current density regions.

In this embodiment, however, the width of the ribs 5b decreases at the upper part of the oxidant gas separator 1b, as described above, and hence in the part of the gas diffusion electrode 1p which overlaps the upper part of the oxidant gas separator 1b, the area of surface contact with the oxidant gas increases. As a result, the gas diffusion is improved, and reductions in the gas diffusion can be suppressed even when the mass flow of the oxidant gas decreases.

Hence reductions in current density caused by a decrease in the mass flow of the gas in the high temperature regions of the cell surface are suppressed, and thus a fuel cell stack exhibiting stability and high performance can be obtained even under operating conditions such as high current density, where diffusion limiting is likely to occur.

It should be noted that in this embodiment, the width of the ribs 5b decreases in stages, but the width of the ribs 5b may be reduced gradually toward the upper part of the oxidant gas separator 1b. Further, a similar constitution may be applied to the fuel gas side as well as the oxidant gas side. Moreover, other than reducing the width of the ribs 5b, the ribs 5b may be formed in a lattice form or the like to reduce the surface area of the ribs 5b contacting the gas diffusion electrode 1p.

Further, the coolant passages 4c are provided on the rear surface of the oxidant gas separator 1b, but instead, a cooling plate may be disposed adjacent to the oxidant gas separator 1b and coolant passages may be provided in the cooling plate.

### Third Embodiment

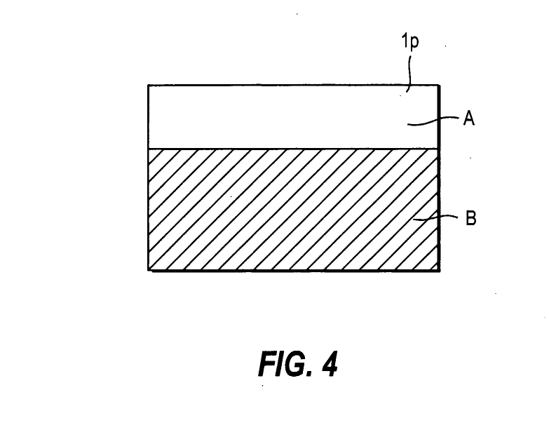

FIG. 4 shows the constitution of the oxidant gas diffusion electrode 1p used in a fuel cell stack of a third embodiment. The basic constitution of the unit cell 11 is identical to that shown in FIG. 1A. Shared constitutions with the first embodiment have been allocated identical reference numerals, and description thereof has been omitted.

The oxidant gas diffusion electrode 1p is constituted by coating the surface of carbon paper with a mixture of carbon powder supporting a platinum catalyst and an electrolytic solution. The outer form of the oxidant gas diffusion electrode 1p is approximately identical to the range of the gas passages 4b provided in the oxidant gas separator 1b.

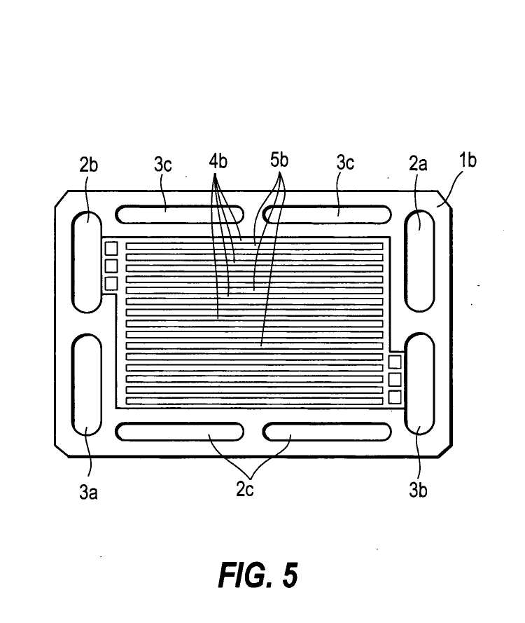

As shown in FIG. 4, a part of the surface of the carbon paper is coated with a mixture of carbon and Teflon before being coated with the mixture of carbon powder supporting a platinum catalyst and the electrolytic solution. A region A which is not coated with the carbon-Teflon mixture is disposed in the upper region of the oxidant gas diffusion electrode 1p, and overlaps the downstream side region of the coolant passages 4c where the temperature is highest. The membrane electrode assembly 1a employing this oxidant gas diffusion electrode 1p, the fuel gas separator 1c, and the oxidant gas separator 1b shown in FIG. 5 are stacked together to form the unit cell 11.

In the oxidant gas diffusion electrode 1p shown in FIG. 4, the region A (the upper part of the drawing), constituted by carbon paper alone and not coated with the carbon-Teflon mixture, has a greater average porosity in the direction of thickness than a coated region B, and hence the oxidant gas diffusion is better in the region A.

In the fuel cell stack 10, temperature distribution over the cell surface is uneven such that the temperature in the downstream region of the coolant passages is high. This surface temperature differential of the gas causes differences to arise in the expansion factor and saturation vapor pressure, leading to a reduction in the mass flow of the oxidant gas flowing in the upper part of the oxidant gas separator 1b. This tendency is particularly striking in high current density regions.

In this embodiment, however, the gas diffusion is improved by increasing the average porosity in the upper part of the gas diffusion electrode 1p adjacent to the oxidant gas separator 1b.

As a result, reductions in current density accompanying a decrease in the mass flow are suppressed, and a fuel cell stack exhibiting stability and high performance can be obtained even under operating conditions such as high current density, where diffusion limiting is likely to occur. Moreover, there is no need to vary the width of the passages 4b or ribs 5b on the separator surface of the oxidant gas separator 1b, as in the previous embodiments, to offset the gas diffusion.

It should be noted that here, the oxidant gas diffusion electrode was cited, but a similar constitution may be applied to the fuel gas diffusion electrode.

### Fourth Embodiment

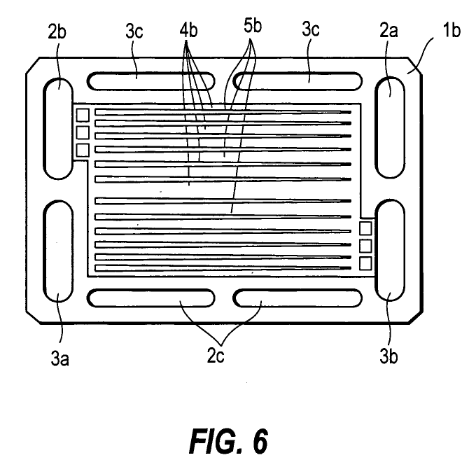

FIG. 6 shows the constitution of the oxidant gas separator 1b used in the fuel cell stack 11 according to a fourth embodiment. The basic constitution of the unit cell 11 is identical to that shown in FIG. 1A. Shared constitutions with the first embodiment have been allocated identical reference numerals, and description thereof has been omitted.

The separator 1b is manufactured from a conductive carbon resin composite. The separator 1b is formed with fuel gas manifolds 2a, 3a, oxidant gas manifolds 2b, 3b, and coolant manifolds 2c, 3c allowing fuel gas, oxidant gas, and coolant to flow respectively in the stacking direction of the fuel cell stack 10. Each manifold serves as either a fluid supply manifold or a fluid discharge manifold.

The separator 1b is provided with a plurality of oxidant gas passages 4b bifurcating from the manifold 2b and extending to the oxidant gas discharge manifold 3b. Ribs 5b having a convex cross section and contacting the gas diffusion electrode 1p to realize a current collecting function are provided between the passages 4b.

The width of the passages 4b increases in stages from the end parts of the surface of the separator 1b toward the center. In addition, the width of the passages 4b increases and the width of the ribs 5b decreases toward the downstream side (the right side of the drawing).

In the fuel cell stack 10, temperature distribution over the cell surface is uneven such that the temperature near the center, where it is difficult for reaction heat to dissipate, is high. This gas temperature differential on the surface causes differences to arise in the expansion factor and saturation vapor pressure, leading to a reduction in the mass flow of the oxidant gas flowing near the center. This tendency is particularly striking in high current density regions. In this embodiment, however, the constitution described above enables the oxidant gas to flow through the passages 4b near the center of the separator more easily than it flows through the passages 4b existing on the outer sides, and hence the gas diffusion near the center can be improved.

Furthermore, in the downstream region where the oxidant gas concentration of the oxidant gas decreases due to an electrode reaction, the ribs 5b decrease in width, and thus in the downstream region, the surface contact area between the oxidant gas and the gas diffusion electrode 1p increases, thereby improving the gas diffusion.

Hence according to this embodiment, reductions in current density accompanying a decreased mass flow near the center of the cell surface can be suppressed, and reductions in current density caused by a decrease in concentration can be prevented even in the downstream area of the reactant gas. As a result, a fuel cell stack exhibiting stability and high performance can be obtained even under operating conditions in which diffusion limiting is likely to occur, such as a high current density operation or an operation with high reactant gas utilization.

It should be noted that in this embodiment, the width of the passages 4b is increased in stages. However, the width of the passages 4b may be increased gradually. Moreover, the reason for altering the width of the passages 4b is to increase the sectional area of the passages 4b, and therefore instead of, or in addition to, altering the width of the passages 4b, the depth of the passages 4b may be altered.

Further, the width of the ribs 5b is reduced in the downstream region of the passages 4b as described above, but other than reducing the width of the ribs 5b, the ribs 5b may be formed in a lattice form or the like to reduce the surface area of the ribs 5b contacting the gas diffusion electrode 1p and increase the surface contact area between the oxidant gas and the gas diffusion electrode 1p. Moreover, a similar constitution may be applied to the separator 1c on the fuel gas side as well as the separator 1b on the oxidant gas side.

### Fifth Embodiment

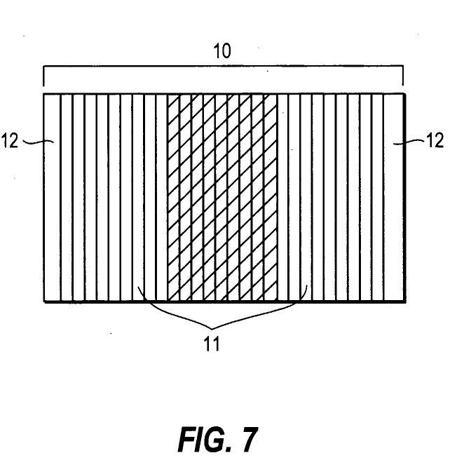

FIG. 7 shows the constitution of a fuel cell stack according to a fifth embodiment.

The fuel cell stack 10 comprises a plurality of stacked unit cells 11. The basic constitution of the unit cell 11 is identical to that shown in FIG. 1A, comprising the membrane electrode assembly 1a, the fuel gas separator 1c, and the oxidant gas separator 1b provided with coolant passages on its rear surface. End plates 12 which also provide a current collecting function are disposed on the two end parts.

The oxidant gas separator 1b used in the plurality of fuel cells 11 positioned near the center in the stacking direction (the section shaded with diagonal lines in FIG. 7) is identical to the oxidant separator 1b shown in FIG. 5 when seen from above, but the passages 4b are comparatively deep, for example 0.50mm. The oxidant gas separator 1b used in the other stacked positions (the non-shaded parts of FIG. 7) is also identical to the oxidant separator 1b shown in FIG. 5 when seen from above, but the passages 4b are comparatively shallow, for example 0.45mm.

Of the stacked unit cells 11, if the unit cells disposed in the center are assumed to constitute a first region and the unit cells 11 disposed on the outer sides of the unit cells 11 disposed in the center are assumed to constitute a second region, then the temperature of the first region is higher than that of the second region. In this embodiment, the width of the passages 4b adjacent to the first region is greater than the width of the passages 4b adjacent to the second region, and hence the passages 4b adjacent to the first region have a larger sectional area.

In the fuel cell stack 10, temperature distribution in the stacking direction is uneven such that the temperature of the unit cells 11 positioned near the center, where heat dissipation is difficult, increases. This temperature difference causes differences to arise in the expansion factor and saturation vapor pressure, leading to a reduction in the mass flow of the oxidant gas flowing through the oxidant gas separators of the unit cells 11 positioned near the center. This tendency is particularly striking in high current density regions.

According to the constitution described above, however, oxidant gas flows through the oxidant gas separators in the unit cells 11 positioned near the center in the stacking direction more easily than it flows through the oxidant gas separators in the unit cells 11 existing in the other stacked positions.

Hence, the gas diffusion in the unit cells 11 positioned near the center of the fuel cell stack 10 in the stacking direction is improved over the gas diffusion of the unit cells 11 in the other stacked positions, enabling reductions in the cell voltage caused by decreased mass flow to be suppressed. As a result, a fuel cell stack exhibiting stability and high performance, and having a uniform cell voltage distribution even under operating conditions in which diffusion limiting is likely to occur, such as high current density in particular, can be obtained.

It should be noted that in this embodiment, the depth of the passages 4b in the separator 1b is varied according to the stacked position in the fuel cell stack 10, but instead of, or in addition to, varying the depth of the passages 4b, the sectional area of the passages 4b may be varied.

Further, the depth of the passages 4b is varied between the plurality of unit cells 11 positioned near the center of the fuel cell stack 10 in the stacking direction and the unit cells 11 positioned in the other parts, but the depth of the passages 4b may be increased gradually from the end parts toward the center. Moreover, this constitution may be applied to the fuel gas side as well as the oxidant gas side.

### Sixth Embodiment

The basic constitution of a fuel cell according to a sixth embodiment of this invention is similar to that of the fifth embodiment shown in FIG. 7. However, the fuel cell stack 10 of this embodiment differs from the fifth embodiment in the constitution of the oxidant gas separator 1b used in the plurality of unit cells 11 positioned near the center in the stacking direction (the section shaded by diagonal lines in FIG. 7). The constitution of the oxidant gas separator used in the other stacked positions (the non-shaded parts of FIG. 7) is identical to that of the oxidant gas separator 1b shown in FIG. 5.

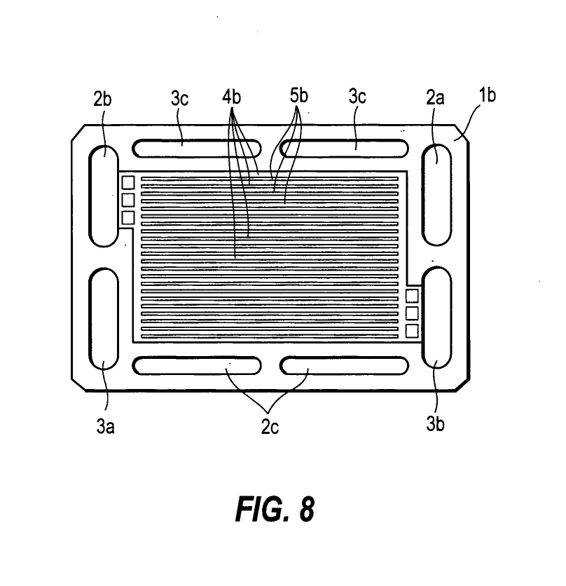

The constitution of the oxidant gas separator 1b used near the center of the stacking direction is shown in FIG. 8. The difference between the oxidant gas separators in FIG. 8 and FIG. 5 is that the oxidant gas passages 4b and the ribs 5b of the oxidant gas separator 1b in FIG. 8 are narrower than those of the separator in FIG. 5. It should be noted, however, that the depth of the passages 4b is the same in both separators, and the total sectional area of all of the passages 4b existing on the surface of a single gas separator 1b is the same in both FIG. 8 and FIG. 5.

In the fuel cell stack 10, temperature distribution in the stacking direction is uneven such that the temperature of the unit cells 11 positioned near the center, where heat dissipation is difficult, increases. This temperature difference causes differences to arise in the expansion factor and saturation vapor pressure, leading to a reduction in the mass flow of the oxidant gas flowing through the oxidant gas separators 1b of the unit cells 11 positioned near the center. This tendency is particularly striking in high current density regions.

In this embodiment, however, by setting the width of the ribs 5b of the oxidant gas separator 1b as described above, the gas diffusion is improved near the center in the stacking direction, and therefore reductions in the gas diffusion are suppressed even when the mass flow of the oxidant gas flowing through the unit cells 11 near the center decreases.

Hence reductions in the cell voltage caused by decreased mass flow in the unit cells 11 positioned near the center of the fuel cell stacking direction are suppressed, and as a result, a fuel cell stack exhibiting stability and high performance, and having a uniform cell voltage distribution even under operating conditions in which diffusion limiting is likely to occur, such as high current density, can be obtained.

It should be noted that in this embodiment, the constitution of the oxidant gas separators in the plurality of unit cells 11 positioned near the center of the stacking direction differs from that of the unit cells 11 positioned in the other parts, but the constitution of the oxidant gas separators may be varied gradually toward the center. The constitution of this embodiment may be applied to the fuel gas side as well as the oxidant gas side.

### Seventh Embodiment

The basic constitution of a fuel cell according to a seventh embodiment of this invention is similar to that of the fifth embodiment shown in FIG. 7. However, in the fuel cell stack 10 of this embodiment, the constitution of the oxidant gas diffusion electrode 1p differs in the plurality of unit cells 11 positioned near the center of the stacking direction (the section shaded by diagonal lines in FIG. 7) and the plurality of unit cells 11 positioned on the end sides (the non-shaded parts of FIG. 7).

More specifically, the coating thickness of the carbon-Teflon mixture that is coated onto the surface of the carbon paper constituting the oxidant gas diffusion electrode 1p is different near the center of the stacking direction and on the end sides. That is, the mixture is coated more thinly onto the gas diffusion electrodes 1p of the fuel cells 11 near the center than the gas diffusion electrodes 1p of the fuel cells 11 on the end sides. It should be noted, however, that the specification of the catalyst layer coated onto the mixture is the same in both cases. Moreover, the constitution of the oxidant gas separator is identical to that shown in FIG. 5.

In the fuel cell stack 10, temperature distribution in the stacking direction is uneven such that the temperature of the unit cells 11 positioned near the center of the stacking direction, where heat dissipation is difficult, increases. This temperature difference causes differences to arise in the expansion factor and saturation vapor pressure, leading to a reduction in the mass flow of the oxidant gas flowing through the oxidant gas separators of the unit cells 11 positioned near the center. This tendency is particularly striking in high current density regions.

In this embodiment, however, the porosity of the oxidant gas diffusion electrode increases toward the center of the stacking direction, leading to improved gas diffusion near the center of the stacking direction.

Hence reductions in the cell voltage caused by decreased mass flow in the unit cells 11 positioned near the center of the fuel cell stack 10 in the stacking direction are suppressed, and as a result, a fuel cell stack exhibiting stability and high performance, and having a uniform cell voltage distribution even under operating conditions in which diffusion limiting is likely to occur, such as high current density, can be obtained.

It should be noted that in this embodiment, the constitution of the oxidant gas diffusion electrode 1p differs in the plurality of unit cells 11 positioned near the center of the stacking direction and the unit cells 11 positioned in the other parts, but the constitution of the oxidant gas diffusion electrode 1p (the coating thickness of the mixture) may be altered gradually from the end parts toward the center.

Moreover, in this embodiment the porosity of the gas diffusion electrode 1p is changed by altering the thickness of the mixture. However, another method, for example changing the porosity of the gas diffusion electrode 1p by not coating the mixture onto the gas diffusion electrodes used near the center of the stacking direction or the like, may be employed. Furthermore, this constitution may be applied to the fuel gas side as well as the oxidant gas side.

### Eighth Embodiment

The basic constitution of the fuel cell stack 10 according to an eighth embodiment of this invention is similar to that of the fifth embodiment shown in FIG. 7. In the eighth embodiment, however, the constitution of the oxidant gas separators used in the plurality of unit cells positioned near the center of the stacking direction (the section shaded by diagonal lines in FIG. 7) is similar to that of the fourth embodiment shown in FIG. 6, and the oxidant gas passages 4b are comparatively deep, for example 0.50 mm. The constitution of the oxidant gas separators used in the unit cells 11 positioned at the end sides (the non-shaded parts of FIG. 7) is also similar to the constitution shown in FIG. 6, but the passages 4b are comparatively shallow, for example 0.45 mm. Further, on the downstream side of the passages 4b, the passages 4b are wide and the ribs 5b are narrow.

In the fuel cell stack 10, temperature distribution over the cell surface is uneven such that the temperature near the center, where heat dissipation is difficult, increases. This surface temperature difference of the gas causes differences to arise in the expansion factor and saturation vapor pressure, leading to a reduction in the mass flow of the oxidant gas flowing near the center. This tendency is particularly striking in high current density regions.

In this embodiment, however, by constituting the gas passages 4b as described above, the oxidant gas flows more easily in the vicinity of the center, and hence the gas diffusion near the center can be improved.

Further, in the downstream region where the oxidant gas concentration of the oxidant gas decreases due to an electrode reaction, the ribs 5b decrease in width, and thus in the downstream region, the surface contact area between the oxidant gas and the gas diffusion electrode 1p increases, enabling an improvement in the gas diffusion.

Also in the fuel cell stack 10, temperature distribution in the stacking direction is uneven such that the temperature of the unit cells 11 positioned near the center, where heat dissipation is difficult, increases. This temperature difference causes a reduction in the mass flow of the oxidant gas flowing through the oxidant gas separators of the unit cells 11 positioned near the center. This tendency is particularly striking in high current density regions.

In this embodiment, however, the depth of the oxidant gas passages 4b is different near the center and at the end sides as described above, and thus the oxidant gas flows more easily through the unit cells 11 near the center. As a result, the gas diffusion can be improved near the center.

Hence in this embodiment, reductions in current density accompanying decreased mass flow near the center of the cell surface can be suppressed, and irregularities in the current density caused by decreased concentration can be prevented even in the downstream region of the reactant gas. Reductions in cell voltage caused by decreased mass flow in the unit cells 11 positioned near the center of the stacking direction can also be suppressed. As a result, a fuel cell stack exhibiting stability and high performance can be obtained even under operating conditions in which diffusion limiting is likely to occur, such as a high current density operation or an operation with high reactant gas utilization.

It should be noted that in this embodiment, by setting the width of the gas passages and ribs on the oxidant gas separator surface similarly to the fourth embodiment, the gas diffusion over the surface can be offset. However, the gas passage form and rib form do not have to be altered, and any constitution that can offset the gas diffusion over the surface may be employed.

Further, in this embodiment, the constitution of the oxidant gas separator is altered in stages between the plurality of unit cells 11 positioned in the center of the stacking direction and the unit cells 11 positioned in the other parts, but the constitution of the oxidant gas separator may be altered gradually from the ends of the stacking direction toward the center. Moreover, the constitution of this embodiment may be applied to the fuel gas side as well as the oxidant gas side.

The entire contents of Japanese Patent Application P2003-410509 (filed Dec. 9, 2003) are incorporated herein by reference.

Although the invention has been described above by reference to a certain embodiment of the invention, the invention is not limited to the embodiment described above. Modifications and variations of the embodiments described above will occur to those skilled in the art, in the light of the above teachings. The scope of the invention is defined with reference to the following claims.

### INDUSTRIAL APPLICABILITY

This invention may be applied to a fuel cell stack to suppress reductions in cell voltage caused by decreased mass flow in high temperature regions, and thus improve the performance of the fuel cell stack.

1-10. (canceled)

11. A fuel cell stack comprising a plurality of stacked unit cells, wherein each unit cell comprises:
a membrane electrode assembly in which gas diffusion electrodes are disposed on each side of a polymer electrolyte membrane; and
a separator comprising a plurality of ribs which contact the membrane electrode assembly to realize a current collecting function, and a plurality of gas passages formed between the ribs for supplying a gas to the gas diffusion electrode,
the fuel cell stack comprises a first region and a second region in the interior thereof, the first region having a higher temperature than the second region, and
at least one of the gas passages, the ribs, and the gas diffusion electrode is constituted such that a gas diffusion through the gas diffusion electrode adjacent to the first region is improved beyond the gas diffusion through the gas diffusion electrode adjacent to the second region.

12. The fuel cell stack as defined in claim 11, wherein the first region is a central region of a surface of the unit cell when seen from a stacking direction of the fuel cell stack, and the second region is a region on an outer side of the first region on the surface of the same unit cell.

13. The fuel cell stack as defined in claim 11, further comprising a plurality of coolant passages through which a coolant flows onto a rear side of the gas passages,
wherein the first region is a region near an outlet from the coolant passages, and the second region is a region on the outer side of the first region.

14. The fuel cell stack as defined in claim 11, wherein the first region comprises unit cells disposed in the center of the plurality of stacked unit cells, and the second region comprises unit cells disposed on the outer side of the unit cells disposed in the center.

15. The fuel cell stack as defined in claim 11, wherein a sectional area of the gas passages adjacent to the first region is larger than the sectional area of the gas passages adjacent to the second region.

16. The fuel cell stack as defined in claim 15, wherein the sectional area of the gas passages adjacent to the first region increases toward a downstream side.

17. The fuel cell stack as defined in claim 11, wherein a width of the ribs adjacent to the first region is smaller than the width of the ribs adjacent to the second region.

18. The fuel cell stack as defined in claim 17, wherein the width of the ribs adjacent to the first region decreases toward the downstream side.

19. The fuel cell stack as defined in claim 11, wherein a porosity of the gas diffusion electrode adjacent to the first region is greater than the porosity of the gas diffusion electrode adjacent to the second region.

20. The fuel cell stack as defined in claim 19, wherein a mixture containing carbon is coated in a smaller amount onto the gas diffusion electrode adjacent to the first region than the gas diffusion electrode adjacent to the second region.
